(19) United States
(12) Patent Application Publication
(10) Pub. No.: US 2007/0093265 A1
(43) Pub. Date: Apr. 26, 2007

(54) System and method for transmitting and receiving data using a mobile terminal and multi function peripheral used in the same system

(75) Inventor: Oleksandr Krykun, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/505,948

(22) Filed: Aug. 18, 2006

(30) Foreign Application Priority Data
Oct. 24, 2005 (KR) 2005-100416

(51) Int. Cl. H04B 1/38; H04M 1/00

(52) U.S. Cl. 455/557

(57) ABSTRACT

A system and method for transmitting and receiving data using a mobile terminal, and a multifunction peripheral in the same system. A transmitter informs a mobile terminal that there is data to transmit, and the mobile terminal searches a printer to print the data and receives printer information about the printer from the searched printer. If the printer is accessible through a wired network, the transmitter transmits the data to the printer. Otherwise, the transmitter transmits the data to the mobile terminal and the mobile terminal transmits the data to the printer. The printer prints the received data. Accordingly, even if a receiver has no facsimile, the receiver can obtain a hardcopy of facsimile data using the mobile terminal.

### CROSS-REFERENCE TO RELATED APPLICATIONS

This application claims the benefit of Korean Application No. 2005-100416, filed on Oct. 24, 2005, in the Korean Intellectual Property Office, the disclosure of which is incorporated herein by reference.

### BACKGROUND OF THE INVENTION

1. Field of the Invention

Aspects of the present invention relate to a system and method for transmitting and receiving data using a mobile terminal and a multifunction peripheral used in the same system. More particularly, the present invention relates to a system and method for transmitting and receiving data using a mobile terminal, which obtains a hardcopy of a facsimile data using a mobile terminal of a receiver, and a multifunction peripheral in the same system.

2. Description of the Related Art

A facsimile is a device that converts characters, figures, and photos into electric signals to send the electric signals to a distant recipient, and reproduces an original image based on the electric signals using a recording converter to obtain a hardcopy.

If a receiver has no facsimile to receive data from a sender facsimile, the receiver cannot obtain a hardcopy of the data. In order to obtain a hardcopy of the data, the receiver has to request the sender facsimile to transmit the facsimile data to a host, which is connected to a printer. This causes inconvenience to the receiver.

### SUMMARY OF THE INVENTION

Aspects of the present invention provide a system and method for transmitting and receiving data using a mobile terminal, which obtains a hardcopy of a facsimile data using a mobile terminal of a receiver and a multifunction peripheral in the same system.

Additional aspects and/or advantages of the invention will be set forth in part in the description which follows and, in part, will be obvious from the description, or may be learned by practice of the invention.

According to an aspect of the present invention, there is provided a method for transmitting and receiving data using a mobile terminal comprising informing a mobile terminal that there is data to transmit with a transmitter, receiving printer information from a printer though a receiver which is to print the data, and transmitting the data to the printer by the transmitter based on the printer information received from the mobile terminal.

Informing the mobile terminal that there is data to transmit with a transmitter may, although not necessarily, include receiving a phone number of a mobile terminal and informing the mobile terminal that there is data to transmit.

The method may, although not necessarily, further include checking-the printer's accessibility, based on the printer information received from the mobile terminal, wherein the transmitter transmits the data to the printer if the printer is accessible.

The method may, although not necessarily, further include transmitting the data to the mobile terminal with the transmitter if the printer is not accessible; and by the mobile terminal, transmitting the received data to the printer.

Transmitting the data to the printer by the transmitter if the printer is accessible may, although not necessarily, be performed after being permitted by the mobile terminal to transmit the data to the printer.

The printer information may, although not necessarily, include information about whether the printer is accessible through a wired network, and a network ID of the printer to access the printer.

The mobile terminal may, although not necessarily, search for a printer to print the data using a wireless interface, and receives the printer information from the searched printer.

The mobile terminal may, although not necessarily, receive from the searched printer user convenience information including at least one of a size of print paper, a physical location of the printer, a printing cost, and a payment way.

According to another aspect of the present invention, there is provided a system for transmitting and receiving data using a mobile terminal, including a transmitter that informs a mobile terminal of a message indicating that there is data to transmit and transmits the data to a printer which is to print the data, based on printer information received from the mobile terminal; the mobile terminal that receives the message from the transmitter and transmits the printer information about the printer which is to print the data to the transmitter, and the printer that prints the data received from the transmitter.

The transmitter may, although not necessarily, receive a phone number of the mobile terminal and inform the mobile terminal having the phone number of the message.

The transmitter may, although not necessarily, check whether the printer is accessible based on the printer information received from the mobile terminal and transmits the data to the printer if the printer is accessible.

The transmitter may, although not necessarily, transmit the data to the mobile terminal if the printer is not accessible, and the mobile terminal may, although not necessarily, transmit the data received from the transmitter to the printer.

If the printer is accessible, the transmitter may, although not necessarily, transmit the data to the printer after being permitted by the mobile terminal to transmit the data to the printer.

The printer information may, although not necessarily, include information about whether the printer is accessible through a wired network, and a network ID of the printer to access the printer.

The printer information may, although not necessarily, be received from a printer that the mobile terminal searches using a wireless interface.

The printer information may, although not necessarily, further include user convenience information including at least one of a size of print paper, a physical location of the printer, a printing cost, and a payment way.

According to another aspect of the present invention, there is provided a multifunction peripheral in a system for transmitting and receiving data using a mobile terminal. The multifunction peripheral includes an input unit that receives a phone number of a mobile terminal, and a controller that informs a mobile terminal having the phone number of a message indicating that there is data to transmit, and transmits the data to a printer which is to print the data, based on printer information about the printer received from the mobile terminal.

The controller may, although not necessarily, check whether the printer is accessible based on the printer information received from the mobile terminal, and if the printer is accessible, transmits the data to the printer.

The controller may, although not necessarily, transmit the data to the mobile terminal if the printer is not accessible.

the printer is accessible, the controller may, although not necessarily, transmit the data to the printer after being permitted by the mobile terminal to transmit the data to the printer.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating a system for transmitting and receiving data according to an embodiment of the present invention;

FIG. 2 is a flowchart illustrating a method for transmitting and receiving data according to an embodiment of the present invention;

FIG. 3 is a view illustrating a method for transmitting and receiving data according to an embodiment of the present invention; and

FIG. 4 is a block diagram illustrating a system for transmitting and receiving data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiment are described below in order to explain the present invention by referring to the figures.

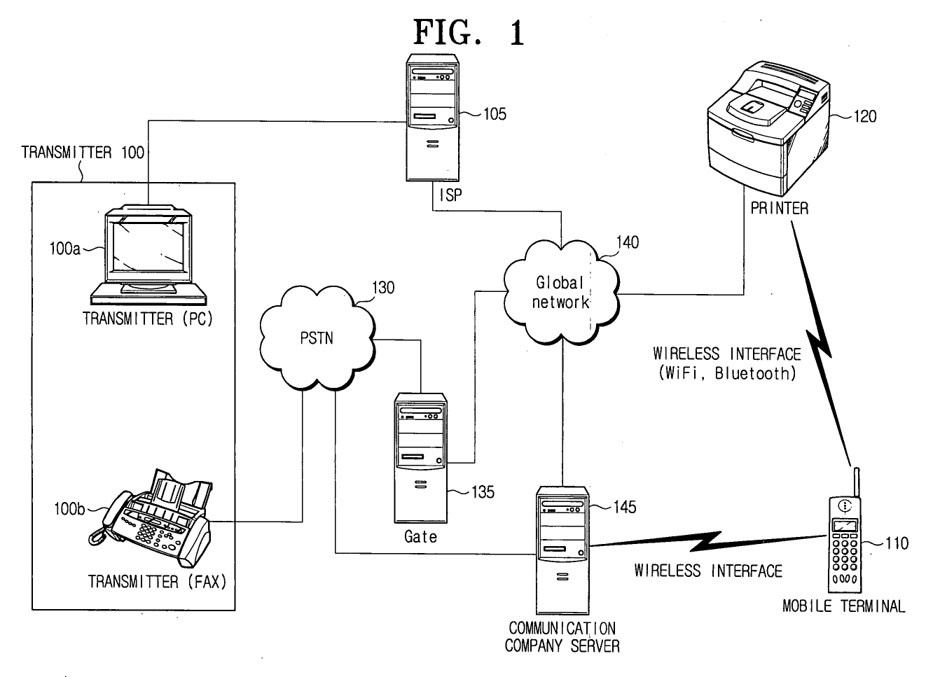

FIG. 1 is a view illustrating a system for transmitting and receiving data according to an embodiment of the present invention.

The system for transmitting and receiving data comprises a transmitter 100, a mobile terminal 110 and a printer 120.

The transmitter 100 refers to a device that has the capability of transmitting text data and image data such as facsimile data, and can be a facsimile 100b, a multifunction peripheral, a personal computer (PC) 100a, a personal digital assistant (PDA), or a laptop PC. The facsimile 100b or the multifunction peripheral is connected to another network 140 through a public switched telephone network (PSTN) 130. Agate 135, which connects at least two communication networks to each other and allows mutual data transmission therebetween, may be used to connect the facsimile 100b to another network 140. The personal computer 100a is connected to another network 140 through an Internet service provider (ISP) 105.

The mobile terminal 110 refers to a terminal device that has the mobility of transmitting and receiving data through a wireless interface. The mobile terminal 110 is connected to another network 140 through a server of a communication company providing a communication service.

The printer 120 prints data received through a wired or wireless interface on printing paper using a developer such as toner.

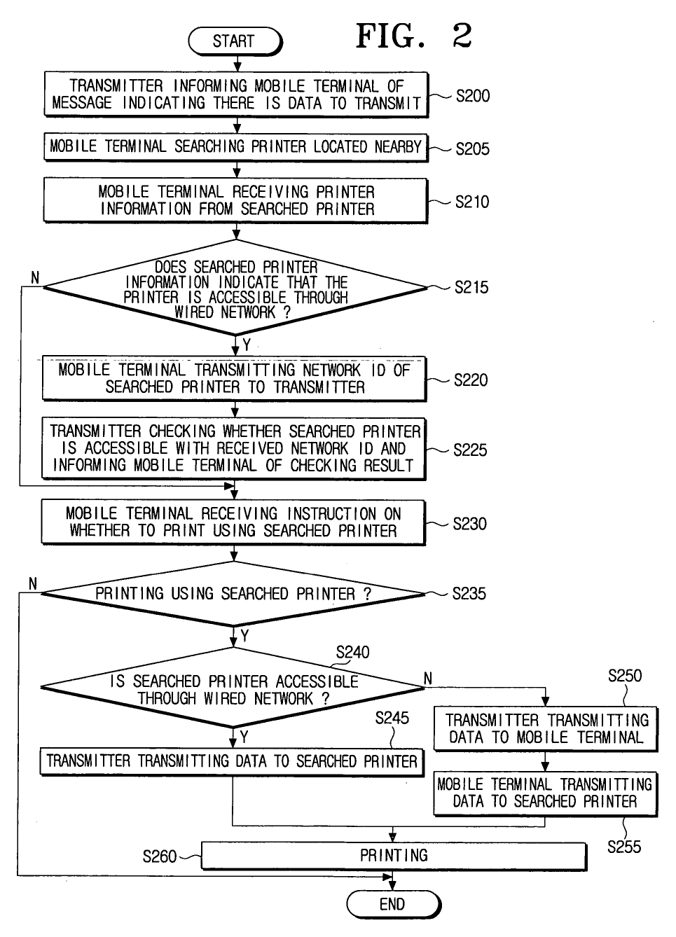

FIG. 2 is a flowchart illustrating a method for transmitting and receiving data according to an embodiment of the present invention. With reference to FIGS. 1 and 2, the present invention will now be described.

At operation S200, the transmitter 100 receives a phone number of the mobile terminal 110 from a user and transmits the message indicating that there is data to be transmitted to the mobile terminal 110. For example, the transmitter 100 transmits the message, “You've got facsimile data,” to the mobile terminal 110 in a short message service (SMS) format such that a user of the mobile terminal 110, i.e., a receiver, is aware of the message.

At operation S205, the mobile terminal 110 searches for a printer 120 located around it after receiving the message at operation S200. Alternatively, the mobile terminal 110 receives an instruction to search for a printer 120 from the receiver and searches for the printer 120. The printer 120 preferably is to be located near to the receiver in order for the receiver to obtain a printed copy of the data transmitted from the transmitter 100. Therefore, it is preferable that the mobile terminal 110 uses a short range wireless interface, such as Bluetooth or WiFi, to search for a printer 120 to print data transmitted from the transmitter 100. The mobile terminal can find more than one printer 120 in its search for a printer 120 to print the data.

Bluetooth refers to a standard that enables computers 100a, mobile terminals 110 or electronics located in a short range to be connected to one another in a wireless manner and enables bi-directional communications in real time. According to current Bluetooth capabilities, the maximum communicable range is 10 meters. WiFi, which stands for a wireless fidelity, refers to a wireless LAN access method of the standard IEEE 802.11.

The mobile terminal 110 requests at least one printer 120 searched at operation S205 for information about the printer 120 (referred to as “printer information” hereinbelow), and receives the printer information from the printer 120 at operation S210. The printer information includes information about whether the printer 120 is accessible through a wired network, and a network ID of the printer 120 necessary to access the printer 120. Herein, the mobile terminal 110 may request information from the printer 120 searched at operation S205. For example, the mobile terminal 110 requests information from a firstly searched printer 120.

The mobile terminal 110 receives user convenience information, such as a paper size of the printer 120 and a physical location of the printer 120, from the printer 120, along with the above-described information. The user convenience information may further include a printing cost and a method of paying for the printing cost.

The mobile terminal 110 determines whether the printer information received at operation S210 indicates that the printer 120 is accessible through the wired network or not, at operation S215.

If the printer information indicates that the printer 120 is accessible through the wired network at operation S215:Y, the mobile terminal 110 transmits a network ID of the printer 120 to the transmitter 100 at operation S220. At this time, the mobile terminal 110 may transmit all network IDs of the printers 120 that give the information indicating the printers 120 are accessible through the wired network at operation S210 to the transmitter 100. Alternatively, the mobile terminal 110 may transmit some of network IDs of the printers 120 that give the information indicating the printers 120 are accessible through the wired network to the transmitter 100, in consideration of paper sizes and physical locations of the printers 120. The network ID is one of an IP address, an e-mail address, and a PSTN number.

The transmitter 100 checks whether the printers 120 are accessible with the network IDs received from the mobile terminal 110, and informs the mobile terminal 110 of the availabilities at operation S225. More specifically, the transmitter 100 determines if it can access the printer 120 with the network ID through the wired network, based on the printer information received by the mobile terminal 110 at operation S210, i.e., the information indicating that the printer 120 is connected to the wired network and thus is accessible through the wired network.

What the mobile terminal 110 requests the transmitter 100 to do is different depending on whether the printer 120 is accessible through the wired network.

If the transmitter 100 informs the mobile terminal 110 that the printer 120 is accessible through the wired network as a result of checking at operation S240:Y, the mobile terminal 110 requests the transmitter 100 to transmit data to the printer 120. According to the request, the transmitter 100 transmits data to the printer 120 through the wired network at operation S245. The printer 120 prints the received data at operation S260. Of course, the printer 120 may store the received data.

If the printer information received at operation S210 indicates that the printer 120 is not accessible through the wired network, or if the transmitter 100 informs the mobile terminal 110 that the printer 120 is not accessible through the wired network as a result of checking at operation S225 (S240:N), the mobile terminal 110 requests the transmitter 100 to transmit data thereto instead of the printer 120. According to the request, the transmitter 100 transmits the data to the mobile terminal 110 at operation S250, and the mobile terminal 110 transmits the data to the printer 120 through a wireless interface at operation S255. The printer 120 prints the received data at operation S260.

More specifically, the mobile terminal 110 displays the printer information received from the printer at operation S210 and the information informed by the transmitter 100 at operation 225 in order for a user of the mobile terminal 110 i.e. the receiver to view them. The receiver selects a printer 120 to print the data received from the transmitter 100 and determines whether to print the data, based on the information displayed on the mobile terminal 110, at operation S230. That is, the receiver selects a printer 120 to print the data in consideration of the paper size, the physical location, the printing cost, and the payment method.

If the mobile terminal 110 receives a command to print data from the receiver at operation S235:Y, the printer 120 receives data and prints the data as described above. At this time, the process of receiving and printing data of the printer 120 is performed after a user makes an electronic payment for the cost to receive and print data transmitted from the transmitter 100 using the mobile terminal 110.

If the mobile terminal 110 does not receive a command to print data from the receiver at operation S235:N, it is not necessary to perform a process of transmitting data to the printer 120.

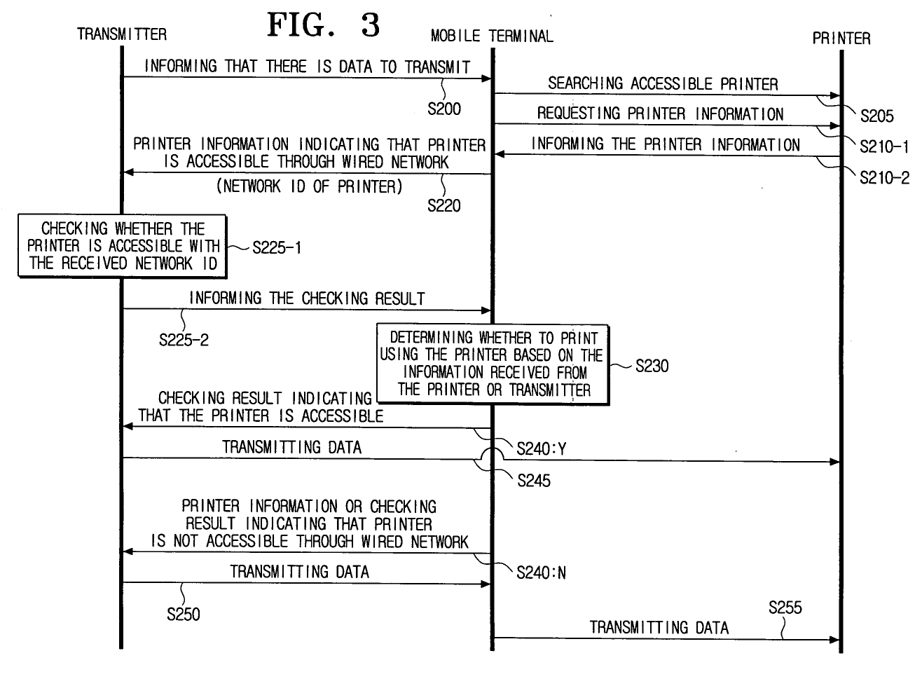

FIG. 3 illustrates the method for transmitting and receiving data as described above in terms of the processes performed among the transmitter 100, the mobile terminal 110 and the printer 120.

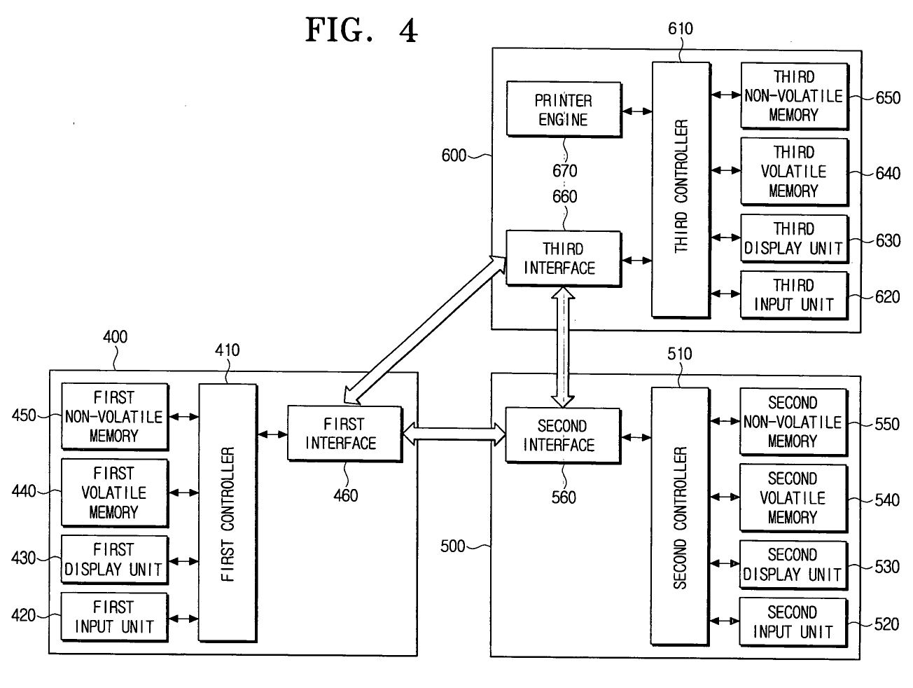

FIG. 4 is a block diagram illustrating a system for transmitting and receiving data according to an embodiment of the present invention. The system comprises a transmitter 400, a mobile terminal 500, and a printer 600.

The transmitter 400 comprises a first controller 410, a first non-volatile memory 450, a first volatile memory 440, a first display unit 430, a first input unit 420, and a first interface 460.

The first input unit 420 comprises at least one manipulation button to receive various user commands. Accordingly, the first input unit 420 receives a phone number of the mobile terminal 500 and a data transmission command. A signal according to a user command, which is input through the first input unit 420, is transmitted to the first controller 410, and the first controller 410 controls the transmitter 400 in response to the signal according to the input user command.

The first display unit 430 displays various messages under the control of the first controller 410 to respond to the input user command or message to inform a user.

The first non-volatile memory 450 stores a control program to perform the operation of the transmitter 400 according to the method for transmitting and receiving data as described above.

The first volatile memory 440 temporarily stores data generated during the operation of the transmitter 400 under the control of the first controller 410.

The first controller 410 controls overall operation of the transmitter 400 according to the control program stored in the first non-volatile memory 450.

The first interface 460 transmits and receives data to and from the mobile terminal 500 and the printer 600 according to the method for transmitting and receiving data as described above.

The mobile terminal 500 comprises a second controller 510, a second non-volatile memory 550, a second volatile memory 540, a second display unit 530, a second input unit 520, and a second interface 560.

The second input unit 520 comprises at least one manipulation button to receive various user commands. Accordingly, the second input unit 520 receives from a user an instruction on whether to print data transmitted from the transmitter 400 using the printer 600. A signal according to the user command, which is input through the second input unit 520, is transmitted to the second controller 510, and the second controller 510 controls the mobile terminal 500 in response to the signal according to the input user command.

The second display unit 530 displays various messages to respond to the input user command or inform a user under the control of the second controller 510. Accordingly, the second display unit 530 displays the message indicating that there is data transmitted from the transmitter 400 in an SMS format. The second display unit 530 may display information about a printer 600 and/or user convenience information received from the printer 600 and the transmitter 400 such that the user can determine whether to print the data transmitted from the transmitter 400 using the printer 600.

The second non-volatile memory 550 stores a control program to perform an operation of the mobile terminal 500 according to the method for transmitting and receiving data as described above.

The second volatile memory 540 temporarily stores data generated during the operation of the mobile terminal 500 under the control of the second controller 510.

The second controller 510 controls overall operations of the mobile terminal 500 according to the control program stored in the second non-volatile memory 550.

The second interface 560 transmits and receives data from and to the transmitter 400 and the printer 600 according to the method for transmitting and receiving data as described above.

The printer 600 comprises a third controller 610, a third non-volatile memory 650, a volatile memory 640, a third display unit 630, a third input unit 620, a third interface 660, and a printer engine 670.

The third input unit 620 comprises at least one manipulation button to receive various user commands. A signal according to an input user command, which is input through the third input unit 620, is transmitted to the third controller 610, and the third controller 610 controls the printer 600 in response to the signal according to the input user command.

The third display unit 630 displays various messages to respond to the input user command or inform a user under a control of the third controller 610.

The third non-volatile memory 650 stores a control program to perform operation of the printer 600 according to the method for transmitting and receiving data as described above.

The third volatile memory 640 temporarily stores data generated during the operation of the printer 600 under the control of the third controller 610.

The third controller 610 controls overall operations of the printer 600 according to the control program stored in the third non-volatile memory 650.

The third interface 660 transmits and receives data to and from the transmitter 400 and the mobile terminal 500 according to the method for transmitting and receiving data as described above.

The printer engine 670 prints data received under the control of the third controller 610.

According to aspects of the present invention as described above, it is possible to obtain a hardcopy of a facsimile data using the mobile terminal of the receiver. First, it is determined whether the printer searched by the mobile terminal is accessible to the transmitter through the wired network. If the printer is accessible to the transmitter, the transmitter transmits data to the printer such that the printer prints the data. In this case, it takes less time to transmit data than in a case that data is transmitted from the transmitter to the printer through the mobile terminal, and a cost-saving effect can be achieved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for transmitting and receiving data comprising:
informing a mobile terminal that there is data to transmit;
sending printer information to the mobile terminal from a printer which is to print the data; and
transmitting the data from a transmitter to the printer or from the transmitter to the mobile terminal to transmit to the printer.

2. The method as claimed in claim 1 further comprising receiving a phone number of the mobile terminal before informing the mobile terminal that there is data to transmit.

3. The method as claimed in claim 1, wherein the data is transmitted from the transmitter to the printer.

4. The method as claimed in claim 3, wherein the data is transmitted to the printer after being permitted by the mobile terminal to transmit the data to the printer.

5. The method as claimed in claim 1, wherein the data is transmitted from the transmitter to the mobile terminal and then transmitted from the mobile terminal to the printer.

6. The method as claimed in claim 1, further comprising checking whether the printer is accessible and transmitting the data to the printer if the printer is accessible.

7. The method as claimed in claim 6, wherein the data is transmitted to the printer after being permitted by the mobile terminal to transmit the data to the printer.

8. The method as claimed in claim 1, further comprising:
transmitting the data from the transmitter to the mobile terminal if the printer is not accessible; and transmitting the data from the mobile terminal to the printer.

9. The method as claimed in claim 1, wherein the printer information comprises information about whether the printer is accessible through a wired network, and a network ID of the printer to access the printer.

10. The method as claimed in claim 1, wherein the mobile terminal searches for the printer to print the data using a wireless interface, and receives the printer information from the searched printer.

11. The method as claimed in claim 9, wherein the printer information further comprises user convenience information comprising at least one of a size of print paper, a physical location of the printer, a printing cost, and a payment method.

12. The method as claimed in claim 1, wherein the transmitter is a facsimile.

13. A system for transmitting and receiving data, the system comprising:
a transmitter that informs a mobile terminal of a message indicating that there is data to transmit and transmits the data to the mobile terminal which then transmits the data to a printer, or transmits the data to the printer which is to print the data, based on printer information received from the mobile terminal;
the mobile terminal that receives the message from the transmitter and obtains the printer information of the printer which is to print the data; and
a printer that prints the data received from the transmitter or received from the mobile terminal.

14. The system as claimed in claim 13, wherein the transmitter receives a phone number of the mobile terminal and informs the mobile terminal having the phone number of the message.

15. The system as claimed in claim 13, wherein the mobile terminal receives printer information from the printer.

16. The system as claimed in claim 13, wherein the transmitter receives the printer information from the mobile terminal.

17. The system as claimed in claim 16, wherein the transmitter checks whether the printer is accessible based on the printer information and transmits the data to the printer if the printer is accessible.

18. The system as claimed in claim 16, wherein, if the printer is accessible, the transmitter transmits the data to the printer after being permitted by the mobile terminal to transmit the data to the printer.

19. The system as claimed in claim 16, wherein the transmitter checks whether the printer is accessible based on the printer information and transmits the data to the mobile terminal if the printer is not accessible, and the mobile terminal transmits the data received from the transmitter to the printer.

20. The system as claimed in claim 13, wherein the printer information comprises information about whether the printer is accessible through a wired network, and a network ID of the printer to access the printer.

21. The system as claimed in claim 15, wherein the printer information is received from the printer that the mobile terminal searches using a wireless interface.

22. The system as claimed in claim 20, wherein the printer information further comprises user convenience information comprising at least one of a size of print paper, a physical location of the printer, a printing cost, and a payment method.

23. The system as claimed in claim 13, wherein the transmitter transmits the data to the mobile terminal, and the mobile terminal transmits the data to the printer.

24. The system as claimed in claim 13, wherein the mobile terminal comprises:
an input unit comprising at least one manipulation button to receive a user command;
a controller that controls the mobile terminal according to a control program and in response to a signal according to the user command;

25. The system as claimed in claim 24, wherein the mobile terminal further comprises:
a non-volatile memory to store the control program;
a volatile memory to temporarily store data generated during an operation of the mobile terminal under a control of the controller;
a display unit to display various messages to respond to the user command or the control of the controller; and
an interface to transmit and receive data from and to the transmitter and the printer.

26. The system as claimed in claim 25, wherein the display unit displays information about the printer and convenience information received from the printer and the transmitter.

27. The system as claimed in claim 13, wherein the transmitter comprises:
an input unit that receives a phone number of the mobile terminal; and
a controller that controls to inform the mobile terminal of a message indicating that there is data to transmit, and controls to transmit the data.

28. The system as claimed in claim 27, wherein the transmitter further comprises:
a non-volatile memory to store a control program to perform operations of the multifunction peripheral;
a volatile memory to temporarily store data generated during operations of the multifunction peripheral;
a display unit to display various messages to respond to the input unit; and
an interface to transmit and receive data.

29. The system as claimed in claim 13, wherein the transmitter is a facsimile.

30. A multifunction peripheral in a system for transmitting and receiving data, the multifunction peripheral comprising:
an input unit that receives a phone number of a mobile terminal; and
a controller that controls to inform the mobile terminal having the phone number of a message indicating that there is data to transmit, and controls to transmit the data to the mobile terminal which is to transmit the data to a printer, or controls to transmit the data to the printer which is to print the data, based on printer information about the printer received from the mobile terminal.

31. The multifunction peripheral as claimed in claim 30, wherein the controller checks whether the printer is accessible based on the printer information received from the mobile terminal, and if the printer is accessible, controls to transmit the data to the printer.

32. The multifunction peripheral as claimed in claim 31, wherein the controller controls to transmit the data to the mobile terminal if the printer is not accessible.

33. The multifunction peripheral as claimed in claim 31, wherein the controller controls to transmit the data to the printer after being permitted by the mobile terminal to transmit the data to the printer.

34. The multifunction peripheral as claimed in claim 30, wherein the controller controls to transmit the data to the mobile terminal, and the mobile terminal transmits the data to the printer.

35. The multifunction peripheral as claimed in claim 30 further comprising:
a non-volatile memory to store a control program to perform operations of the multifunction peripheral;
a volatile memory to temporarily store data generated during operations of the multifunction peripheral;
a display unit to display various messages to respond to the input unit; and
an interface to transmit and receive data.

36. A system for transmitting and receiving data, the system comprising:
a transmitter that informs a mobile terminal of a message indicating that there is data to transmit and transmits the data to a printer which is to print the data or the mobile terminal, based on printer information received from the mobile terminal;
the mobile terminal that receives the message from the transmitter and transmits the printer information to the transmitter; and
the printer that prints the data received from the transmitter or the mobile terminal.

37. The system as claimed in claim 36, wherein the transmitter receives a phone number of the mobile terminal.

38. The system as claimed in claim 36, wherein the transmitter checks whether the printer is accessible based on the printer information and transmits the data to the printer if the printer is accessible.

39. The system as claimed in claim 36, wherein the transmitter checks whether the printer is accessible based on the printer information and transmits the data to the mobile terminal if the printer is not accessible, and the mobile terminal transmits the data received from the transmitter to the printer.

40. The system as claimed in claim 36, wherein the transmitter transmits the data to the printer after being permitted by the mobile terminal to transmit the data to the printer.

41. The system as claimed in claim 36, wherein the printer information comprises information about whether the printer is accessible through a wired network, and a network ID of the printer to access the printer.

42. The system as claimed in claim 36, wherein the printer information is received from the printer that the mobile terminal searches using a wireless interface.

43. The system as claimed in claim 41, wherein the printer information further comprises user convenience information comprising at least one of a size of print paper, a physical location of the printer, a printing cost, and a payment method.

44. The system as claimed in claim 36, wherein the transmitter is a facsimile.
